(19) United States
(12) Patent Application Publication
(10) Pub. No.: US 2016/0156084 A1
(43) Pub. Date: Jun. 2, 2016

(54) APPARATUS AND METHOD FOR CONTROLLING CONVERTER

(71) Applicant: Hyundai Motor Company, Seoul (KR)

(72) Inventors: Ji Tae Kim, Yongin (KR); Sung Suk Ok, Suwon (KR); Kyu Il Lee, Yongin (KR); Seong Pil Ryu, Busan (KR)

(21) Appl. No.: 14/844,176

(22) Filed: Sep. 3, 2015

(30) Foreign Application Priority Data
Dec. 2, 2014 (KR) 10-2014-0170798

(51) Int. Cl. H01M 16/00; H01M 8/04

(52) U.S. Cl. CPC H01M 16/006; H01M 8/04902; H01M 8/04873

(57) ABSTRACT

An apparatus for controlling a converter includes: a failure detector that detects failure of a sensor included in an input or output side of the converter, a substitution factor calculator that calculates a substitution factor based on a measurement value of a sensor in a high voltage battery connected to an input side of the converter when failure is detected in the sensor of the input side by the failure detector and calculates the substitution factor based on measurement values of a sensor connected to one or more loads when failure is detected in the sensor of the output side, and an emergency operation controller that controls an operation in a constant current or constant voltage scheme based on the calculated substitution factor.

### CROSS-REFERENCE TO RELATED APPLICATION

This application claims under 35 U.S.C. §119(a) the benefit of Korean Patent Application No. 10-2014-0170798, filed on Dec. 2, 2014 in the Korean Intellectual Property Office, the entire contents of which are incorporated herein by reference.

### BACKGROUND

(a) Technical Field

The present invention relates to an apparatus and method for controlling a converter, and more particularly, to an apparatus disposed between a high voltage battery, and a load and a fuel cell stack, and a method for controlling the converter.

(b) Description of the Related Art

Various functions for controlling a fuel cell vehicle may be generally divided into a fuel cell system control function including an air supply function and a hydrogen supply function into a fuel cell system, a heat management function, a power distribution function for power distribution of a high voltage battery and the fuel cell system, and a vehicle control function for driving a vehicle depending on an intention of a driver. In order to perform the above-mentioned control functions, a controller determines and performs the control functions based on a sensor input, so as to drive an actuator. However, in the case in which a problem may occur in reliability of a sensor, it is impossible to efficiently drive a system and may cause injury to a driver or a pedestrian.

### SUMMARY

An aspect of the present invention provides an apparatus and method for controlling a converter capable of allowing an emergency operation of a sensor to be performed by using information of apparatuses around the converter, when a failure of the sensor included in the converter of a fuel cell vehicle is detected and consequently, the sensor does not perform its existing control function.

An aspect of the present invention provides an apparatus and method for controlling a converter capable of providing reliability and stability to an entire vehicle system by preventing malfunction due to failures of sensors in the converter and thus improve cooperative control performance between the respective components in the vehicle system.

The aspects of the present invention are not limited to the aspects described above, and other aspects that are not described above may be clearly understood by those skilled in the art from the following description.

According to an embodiment of the present invention, an apparatus for controlling a converter includes a failure detector, a substitution factor calculator, and an emergency operation controller. The failure detector detects failure of at least one sensor (i.e., a sensor of an input side and/or a sensor of an output side) included in a converter. The substitution factor calculator calculates a substitution factor based on a measurement value of a sensor in a high voltage battery connected to an input side of the converter when failure is detected in the sensor of the input side by the failure detector and calculate the substitution factor based on measurement values of a sensor connected to one or more loads when failure is detected in the sensor of the output side. The emergency operation controller controls an operation in a constant current or constant voltage scheme based on the calculated substitution factor.

According to another embodiment of the present invention, a method for controlling a converter includes, detecting, by a failure detector, failure of at least one sensor included in a converter, calculating, by a substitution factor calculator, a substitution factor based on a measurement value of a sensor in a high voltage battery connected to the converter when failure is detected in the sensor of an input side in the converter by the failure detector and calculating the substitution factor based on measurement values of a sensor connected to one or more loads when failure is detected in the sensor of an output side, and controlling, by an emergency operation controller, an operation in a constant voltage or constant current scheme based on the calculated substitution factor.

### BRIEF DESCRIPTION OF THE DRAWINGS

The above and other objects, features and advantages of the present invention will be more apparent from the following detailed description taken in conjunction with the accompanying drawings.

FIG. 1 is a block diagram showing a vehicle system including an apparatus for controlling a converter according to an embodiment of the present invention.

FIG. 2 is a block diagram showing the apparatus for controlling the converter according to an embodiment of the present invention.

FIGS. 3 and 4 are flow charts for describing a method for controlling a converter according to an embodiment of the present invention.

### DETAILED DESCRIPTION

Hereinafter, embodiments of the present invention will be described in detail with reference to the accompanying drawings. The same reference numerals will be used to describe the same components throughout the accompanying drawings, and an overlapped description of the same components will be omitted.

In embodiments of the present invention disclosed in the present specification, specific structural and functional descriptions are only to describe embodiments of present invention, and embodiments of the present invention may be implemented in various forms and are not to be interpreted to be limited to embodiments described in the present specification.

In addition, in describing the components of the present invention, terms such as first, second, A, B, etc. can be used. These terms are used only to differentiate the components from other components. Therefore, the nature, order, sequence, etc. of the corresponding components are not limited by these terms.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Further, the control logic of the present invention may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

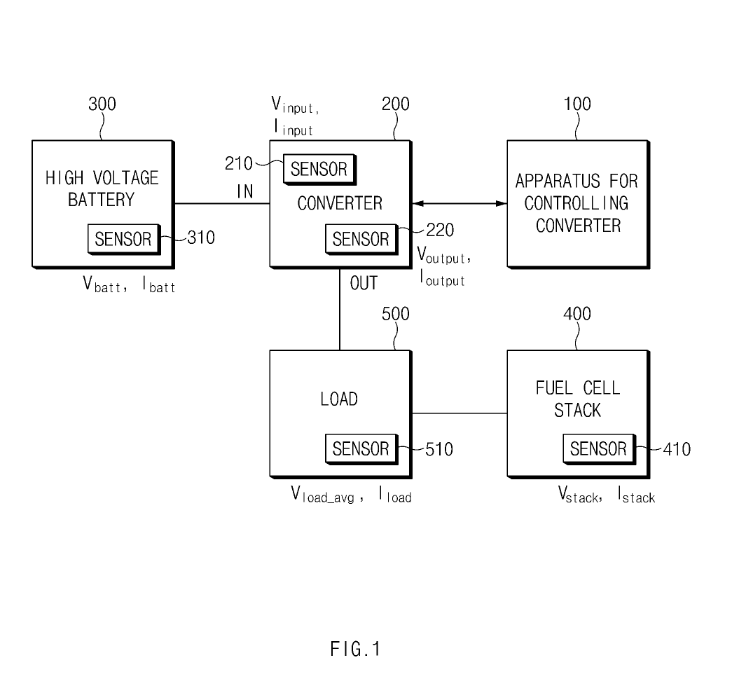

FIG. 1 is a block diagram showing a vehicle system including an apparatus for controlling a converter according to an embodiment of the present invention.

Referring to FIG. 1, a vehicle system may include an apparatus 100 for controlling a converter, a converter 200, a high voltage battery 300, a fuel cell stack 400, and a load 500.

The converter 200, which is a so-called high voltage DC-DC converter, serves to charge the high voltage battery 300 or provide power from the high voltage battery 300 to the load 500 in electric vehicles such as a hybrid electric vehicle (HEV), a fuel cell vehicle, a fuel cell hybrid vehicle, and the like.

The converter 200 may boost a voltage received from the high voltage battery 300 so as to provide the boosted voltage to the load 500 or provide the boosted voltage to the fuel cell stack 400 through the load 500.

The converter 200 includes a voltage and current sensor 210 of an input side so as to sense a voltage measurement value Vᵢₙₚᵤₜ and a current measurement value Iᵢₙₚᵤₜ of the input side connected to the high voltage battery 300. In addition, the converter 200 includes a voltage and current sensor 220 of an output side so as to sense a voltage measurement value Vₒᵤₜₚᵤₜ and a current measurement value Iₒᵤₜₚᵤₜ of the output side connected to the load 500.

The apparatus 100 for controlling the converter may receive the measurement values from the converter 200, the high voltage battery 300 of the input side of the converter 200, and the load 500 of the output side of the converter 200 and may calculate appropriate substitution factor values even in the case in which failure of at least one of the sensors 210 and 220 in the converter 200 is detected, so as to perform control in an emergency mode.

Conventionally, since the apparatus 100 for controlling the converter only performs failure detection regarding disconnection or a short circuit of the sensors 210 and 220 in the converter 200, it immediately stops control of the converter 200 in the case in which the disconnection or the short circuit of the sensors 210 and 220 is detected and also stops an energy supply of the high voltage battery 300 and a transfer of regeneration energy generated by a braking at the same time. In this case, since the vehicle is driven by only pure energy of the fuel cell stack, the vehicle is driven in an emergency mode drive in which an output is limited at the time of acceleration and deceleration, and performs a limphome control that informs the driver about the failure.

According to a conventional vehicle system, there is no choice but to select a single source drive from two sources due to the failure of the converter of the high voltage battery in a hybrid mode drive state, but if key hardware (IGBT, a power circuit, a control circuit, CPU, and the like) is normally operated in a malfunction stage of the sensors 210 and 220 included in the converter 200, other methods for control and monitoring may be sought.

Therefore, the apparatus 100 for controlling the converter according to an embodiment of the present invention detects a position of the sensor (i.e., the sensor 210 of the input side and/or the sensor 220 of the output side) in which failure occurs among the sensors 210 and 220 in the converter 200 and a kind of sensor (i.e., a voltage sensor or a current sensor) in which failure occurs, so as to calculate substitution factors required for the respective cases.

Since the emergency mode control is performed by the substitution factor calculation, both the two sources of the high voltage battery 300 and the fuel cell stack 400 may be utilized even in the case in which failure of the sensor in the converter 200 is detected.

The high voltage battery 300 connected to the input side of the converter 200 includes a voltage and current sensor 310 so as to provide a voltage sensor measurement value V_{batt} of the high voltage battery and a current sensor measurement value I_{batt} of the high voltage battery.

The load 500 connected to the output side of the converter 200 may also include a voltage and current sensor 510. The load 500 may be configured of one or more loads, and the respective loads may include the sensors so as to provide the voltage measurement value and the current measurement value. Therefore, a total of voltage measurement values of one or more loads may be an average value V_{load}_{_}_{avg} of the values measured by the voltage sensors included in the respective loads, and the current measurement value may be expressed by a summation L_{load} of values L_{load}_{_}_{avg} measured by the current sensors included in the respective loads.

The fuel cell stack 400 may be used as a main power source of the hybrid vehicle and supplies fuel cell energy to the high voltage battery 300 and a motor driving the vehicle. The fuel cell stack 400 also includes a sensor 410 so as to sense a voltage V_{stack} of the fuel cell stack and a current L_{stack} of the fuel cell stack

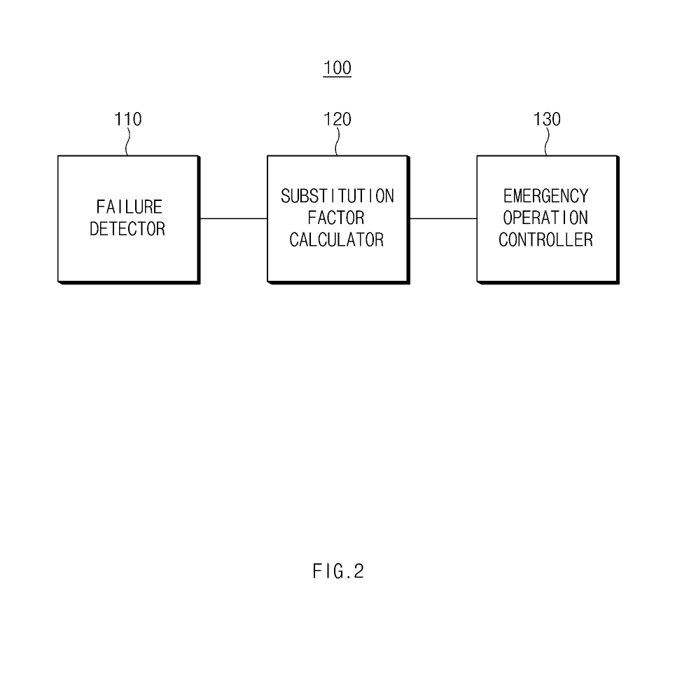

FIG. 2 is a block diagram showing the apparatus for controlling the converter according to an embodiment of the present invention.

Referring to FIG. 2, the apparatus 100 for controlling the converter may include a failure detector 110, a substitution factor calculator 120, and an emergency operation controller 130.

The failure detector 110 detects failure of the sensor 210 of the input side or the sensor 220 of the output side that is included in the converter 200. As described above, the sensor 210 of the input side and the sensor 220 of the output side may each include the voltage sensor and the current sensor. The failure detector 110 may detect whether the sensor in which the failure occurs is the sensor 210 of the input side or the sensor 220 of the output side, and detect whether the failure occurs in any kind of sensor among the sensors.

A method for calculating a substitution factor by the substitution factor calculator 120 may be varied depending on the position and kind of sensor in which the failure is detected by the failure detector 110.

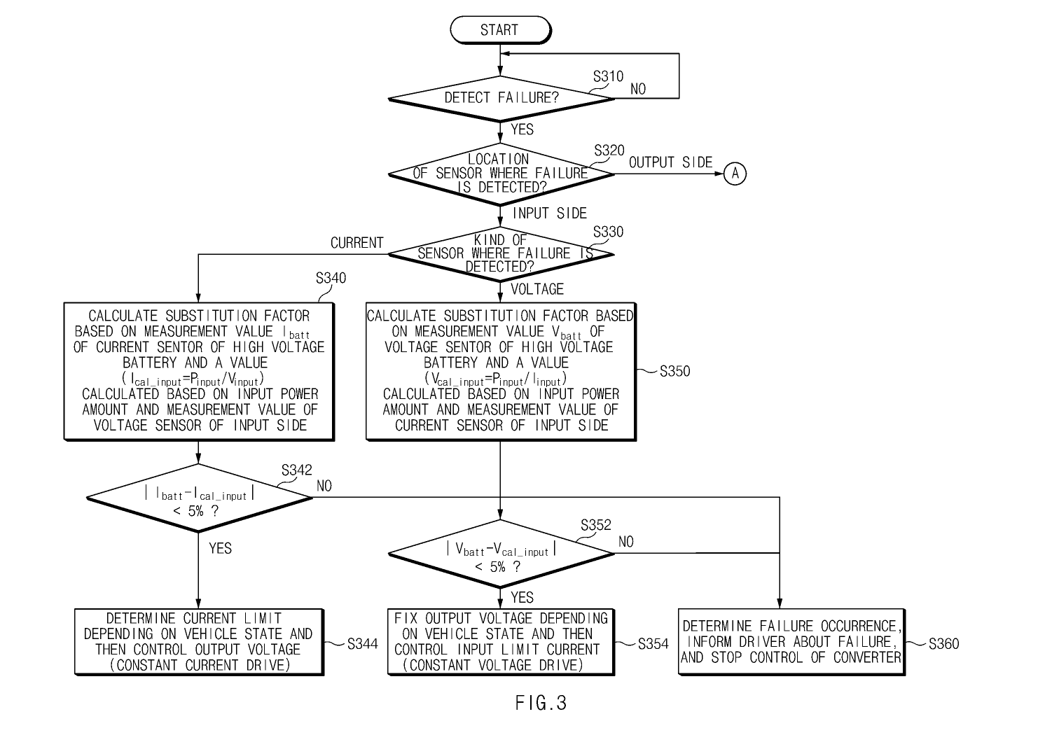

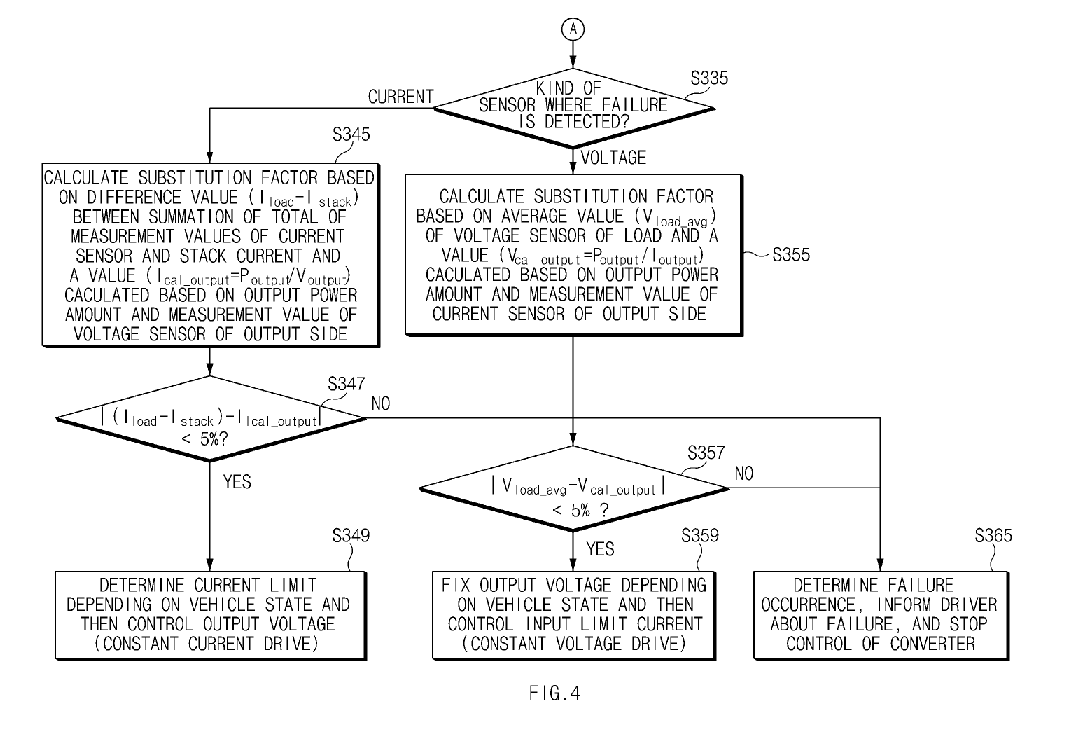

The substitution factor calculator 120 may calculate the substitution factor based on a measurement value of the sensor 310 included in the high voltage battery 300 connected to the input side of the converter 200, in the case in which the failure occurs in the sensor 210 of the input side depending on the failure detection of the failure detector 110. On the contrary, the substitution factor calculator 120 may calculate the substitution factor based on a measurement value of the sensor 510 connected to the load 500 connected to the output side of the converter 200, in the case in which the failure occurs in the sensor 220 of the output side. A method for calculating a substitution factor will be described in detail with reference to FIGS. 3 and 4.

The emergency operation controller 130 may control an operation of the converter 200 in a constant voltage or constant current scheme based on the substitution factor calculated by the substitution factor calculator 120.

According to an embodiment of the present invention, in the case in which the substitution factor calculated by the substitution factor calculator 120 is in a preset range, the emergency operation controller 130 may perform an emergency operation. For example, in the case in which the failure is detected in the current sensor of the converter 200, the substitution factor may correspond to a current based value. In this case, since the current value is utilized by estimating values received from apparatuses around the converter 200, the emergency operation controller 130 may perform a constant current drive that controls an output voltage after a current limitation is determined, depending on a vehicle state.

As another scheme, in the case in which the failure is detected in the voltage sensor of the converter 200, the substitution factor may correspond to a voltage based value. In this case, since the voltage value is an estimation value, the emergency operation controller 130 may control the emergency operation by performing a constant voltage drive that controls an input limit current after an output voltage is fixed, depending on the vehicle state.

On the contrary, in the case in which the substitution factor is out of the preset range, the emergency operation controller 130 may determine a failure occurrence and stop the control of the converter 200. According to another embodiment of the present invention, the emergency operation controller 130 may inform a user through an output apparatus such as a display or a speaker that the failure occurrence is determined.

FIGS. 3 and 4 are flow charts for describing a method for controlling a converter according to an embodiment of the present invention.

Referring to FIG. 3, the failure detector 110 detects a failure of at least one of the sensors 210 and 220 in the converter 200 (S310). If the failure is not detected (NO in S310), the failure detector 110 repeatedly detects the failure based on a preset period.

If the failure is detected (YES in S310), a position when the failure is detected is checked (S320). If the failure is detected in the input side (input side in S320), a kind of failure sensor is detected (S330). An operation of a case in which the failure is detected in the output side (output side in S320) will be described below with reference to FIG. 4.

If the sensor in which the failure is detected is the current sensor (current in S330), the substitution factor calculator 120 calculates the substitution factor based on the measurement value I_{batt} of the current sensor of the high voltage battery 300, an input power amount Pᵢₙₚᵤₜ received from a high rank controller, and the measurement value Vᵢₙₚᵤₜ of the voltage sensor of the input side of the converter 200.

According to an embodiment of the present invention, the substitution factor calculator 120 included in the apparatus 100 for controlling the converter may receive the measurement value from the sensor 310 of the high voltage battery 300 in the case in which the failure is detected in the input side and may receive the measurement value from the sensor 510 of the load 500 in the case in which the failure is detected in the output side. In other words, the substitution factor calculator 120 may selectively receive the measurement values of external sensors depending on the position where the failure is detected.

In a similar scheme, the substitution factor calculator 120 may receive the input power amount Pᵢₙₚᵤₜ from the high rank controller in the case in which the failure is detected in the sensor 210 of the input side of the converter 200, may receive an output power amount Pₒᵤₜₚᵤₜ from the high rank controller in the case in which the failure is detected in the sensor 220 of the output side of the converter 200, and so forth. That is, the substitution factor calculator 120 may selectively receive different kinds of information from the high rank controller depending on the position at which the failure is detected.

A process of calculating a substitution factor by the substitution factor calculator 120 will be described in more detail.

If the failure occurs in the current sensor of the input side of the converter 200, the substitution factor calculator 120 considers the measurement value I_{batt} of the current sensor corresponding to a value of current flowing in the high voltage battery 300 that is close to the input side as one current estimation values.

In addition, the substitution factor calculator 120 calculates another current estimation value by utilizing the value Pᵢₙₚᵤₜ provided by the high rank controller as an actual input power amount of the high voltage battery 300 and the measurement value Vᵢₙₚᵤₜ of the voltage sensor of the input side which is normally operated in the converter 200. The substitution factor calculator 120 calculates a difference between the calculated input current estimation value (I_{cal}_{_}ᵢₙₚᵤₜ=Pᵢₙₚᵤₜ/Vᵢₙₚᵤₜ) and the measurement value I_{batt} of the current sensor of the high voltage battery 300, as the substitution factor (S340).

In other words, the substitution factor calculator 120 considers two current values of the measurement value I_{batt} of the current sensor of the high voltage battery 300 and the calculated input current value (I_{cal}_{_}ᵢₙₚᵤₜ=Pᵢₙₚᵤₜ/Vᵢₙₚᵤₜ) as values capable of substituting the value of the current sensor in which failure occurs, as the estimation values, and calculates a difference between the two current values as the substitution factor so as to provide the substitution factor (|I_{batt}−I_{cal}_{_}ᵢₙₚᵤₜ|) to the emergency operation controller 130.

The emergency operation controller 130 determines whether or not current estimation values that are not directly measured by the current sensor of the converter 200 are reliable by receiving the substitution factor provided from the substitution factor calculator 120. The emergency operation controller 130 determines whether or not the substitution factor (|I_{batt}−I_{cal}_{_}ᵢₙₚᵤₜ|) is in a preset error range (e.g., 5%) (S342).

If the substitution factor is in the error range (YES in S342), the emergency operation controller 130 considers that the two current values which are estimated by the substitution factor calculator 120 as the next best thing have reliability in some degree and performs a constant current drive based on at least one of the measurement value I_{batt} and the calculated input current value (I_{cal}_{_}ᵢₙₚᵤₜ=Pᵢₙₚᵤₜ/Vᵢₙₚᵤₜ) (S344).

If the substitution factor is out of the error range (NO in S342), the emergency operation controller 130 considers that the estimated current values are not reliable and stops the control of the converter 200 by determining the failure occurrence.

If the control of the converter 200 is stopped, the vehicle is consequently supplied with power depending on only the fuel cell stack 400.

If the failure detector 110 detects the failure in the voltage sensor of the sensor 210 of the input side of the converter 200 (voltage in S330), the substitution factor calculator 120 receives the measurement value V_{batt} of the voltage sensor of the high voltage battery 300 as one voltage estimation value and calculates a difference between the measurement value V_{batt} of the voltage sensor of the high voltage battery 300 and the input voltage estimation value (V_{cal}_{_}ᵢₙₚᵤₜ=Pᵢₙₚᵤₜ/Iᵢₙₚᵤₜ) calculated based on the input power amount Pᵢₙₚᵤₜ received from the high rank controller and the measurement value Iᵢₙₚᵤₜ of the current sensor of the input side of the converter 200, as the substitution factor.

Similar to the case in which failure is detected in the current sensor of the input side of the converter 200, if failure is detected in the voltage sensor of the input side, the substitution factor calculator 120 also receives the measurement value V_{batt} of the voltage sensor of the high voltage battery 300 as one voltage estimation value and considers the input voltage estimation value (V_{cal}_{_}ᵢₙₚᵤₜ=Pᵢₙₚᵤₜ/Iᵢₙₚᵤₜ) calculated based on the input power amount Pᵢₙₚᵤₜ and the measurement value Iᵢₙₚᵤₜ of the current sensor of the input side of the converter 200, as the other substitution factor.

The substitution factor calculator 120 calculates a difference between the two voltage estimation values as the substation factor (|V_{batt}−V_{cal}_{_}ᵢₙₚᵤₜ|) and provides the substitution factor to the emergency operation controller 130 (S350).

If the substitution factor is in the preset error range (e.g., 5%) (YES in S352), the emergency operation controller 130 determines the corresponding voltage estimation value to be a reliable value, and performs the constant voltage drive that fixes the output voltage depending on the vehicle state and then limits an input limit current (S354).

On the other hand, if the substitution factor is out of the preset error range (NO in S352), the emergency operation controller 130 determines the failure occurrence and stops the control of the converter 200 (S360).

FIG. 4 is a flow chart describing an operation of the case in which the failure occurs in the sensor of the output side of the converter 200.

Referring to FIG. 4, the failure detector 110 determines a kind of sensor in which the failure is detected at the output side. If the sensor in which the failure is detected is the current sensor of the output side (current in S335), the substitution factor may be calculated, similarly to the case in which the failure is detected in the current sensor of the input side.

Specifically, the substitution factor calculator 120 obtains a summation I_{load} of the measurement values of the current sensor of the load 500 connected to the output side of the converter 200. The output side of the converter 200 may be connected with one or more loads, and a difference value between a total summation I_{load} of currents flowing in the loads and a current L_{stack} flowing in the fuel cell stack 400 is considered as one of the estimation values of the current flowing in the output side of the converter 200.

As can be seen in FIG. 1, since the converter 200 is connected to the fuel cell stack 400 through the load 500, a value obtained by substituting the current I_{stack} flowing in the fuel cell stack 400 from the current I_{load} flowing in the entire load 500 may be estimated as a current output from the converter 200.

The substitution factor calculator 120 considers the current estimation value (I_{cal}_{_}ₒᵤₜₚᵤₜ=Pₒᵤₜₚᵤₜ/Vₒᵤₜₚᵤₜ) calculated based on the measurement value Vₒᵤₜₚᵤₜ of the voltage sensor of the output side of the converter 200 and the output power amount Pₒᵤₜₚᵤₜ received from the high rank controller as the other current estimation value.

Finally, the substitution factor calculator 120 calculates a value obtained by substituting the calculated current estimation value (I_{cal}_{_}ₒᵤₜₚᵤₜ=Pₒᵤₜₚᵤₜ/Vₒᵤₜₚᵤₜ) from a difference value between the summation I_{load} of the measurement values of the current sensor of the load 500 and the current I_{stack} flowing in the fuel cell stack 400 as the substitution factor (S345).

If the substitution factor received from the substitution factor calculator 120 is in the preset error range (e.g., 5%) (YES in S347), the emergency operation controller 130 determines performs the constant current drive that determines a current limit depending on the vehicle state and then controls the output voltage (S349).

If the substitution factor is out of the preset error range (NO in S347), the emergency operation controller 130 may determine the failure occurrence, stop the control of the converter 200, and inform the driver that the failure occurrence is determined according to an embodiment of the present invention (S365).

If the failure is detected in the voltage sensor of the output side (voltage in S335), the substitution factor calculator 120 may similarly utilize the two voltage estimation values. One voltage estimation value is an average value (V_{load}_{_}_{avg}) of the voltages sensed in one or more loads 500 connected to the output side of the converter 200. In the case in which the value of the current flowing in the output side is calculated, the values of the currents flowing in one or more loads 500 are all added. However, in case of voltage, values of the voltages across the respective load 500 are averaged. In addition, the other voltage estimation value is calculated based on the output power amount Pₒᵤₜₚᵤₜ received from the high rank controller and the measurement value Iₒᵤₜₚᵤₜ of the current sensor of the output side of the converter 200. The substitution factor calculator 120 calculates a difference between the calculated voltage estimation value (V_{cal}_{_}ₒᵤₜₚᵤₜ=Pₒᵤₜₚᵤₜ/Iₒᵤₜₚᵤₜ) and the voltage average value (V_{load}_{_}_{avg}) of the load 500, as the substitution factor (|V_{load}_{_}_{avg}−V_{cal}_{_}ₒᵤₜₚᵤₜ|) (S355).

The emergency operation controller 130 determines whether or not the substitution factor received from the substitution factor calculator 120 is in the preset error range (S357).

If the substitution factor is in the preset error range (YES in S357), the emergency operation controller 130 performs the constant voltage drive that fixes the output voltage depending on the vehicle state and then controls the input limit current (S359).

On the other hand, if the substitution factor is out of the preset error range (NO in S357), the emergency operation controller 130 determines the failure occurrence and stops the control of the converter 200 (S365).

The apparatus for controlling the converter and the method for controlling the converter according to the embodiments of the present invention as described above utilize the values of the sensor measuring the voltage and current of the high voltage battery 300 which is input side and the sensor measuring the voltage and current of the load 500 which is the output side in the case in which the failure is detected in some of the sensors in the converter 200 of the fuel cell vehicle. In addition, the voltage and current estimation values are calculated by the input power amount and the output power amount of the converter 200 that are received from the high rank controller through intra-vehicle communication such as CAN and the measurement values of the voltage and current sensors that are normally operated in the converter 200, such that the emergency operation of the converter may be performed.

As such, in the case in which the failure is detected in some sensors in the converter 200, only the fuel cell stack 400 is not used, but the converter 200 is controlled by utilizing the measurement values of the apparatuses around the converter 200, thereby making it possible to improve cooperative control performance of the vehicle system and increase reliability and stability of the entire system.

As described above, according to the embodiments of the present invention, the apparatus for controlling the converter and the method for controlling the converter may perform the control operation in case of emergency by predicting the voltage and current values of the converter utilizing measurement values from the sensor of the input side or the output side connected to the converter even in the case in which the failure of the sensor in the converter occurs. Therefore, even in the case in which the failure occurs in the converter, since the vehicle is driven by only pure energy in the fuel cell stack, it is possible to avoid a situation in which an output is limited at the time of acceleration or deceleration of the vehicle.

Further, the embodiments of the present invention have been provided for illustrative purposes. Therefore, those skilled in the art will appreciate that various modifications, alterations, substitutions, and additions are possible without departing from the scope and spirit of the invention as disclosed in the accompanying claims and such modifications, alterations, substitutions, and additions fall within the scope of the present invention.

It will be obvious to those skilled in the art to which the present invention pertains that the present invention described above is not limited to the above-mentioned embodiments and the accompanying drawings, but may be variously substituted, modified, and altered without departing from the scope and spirit of the present invention.

What is claimed is:

1. An apparatus for controlling a converter, the apparatus comprising:
a failure detector configured to detect failure of at least one sensor included in an input side or an output side of a converter;
a substitution factor calculator configured to calculate a substitution factor based on a measurement value of a sensor in a high voltage battery connected to an input side of the converter when failure is detected in the sensor of the input side by the failure detector, and calculate the substitution factor based on measurement values of a sensor connected to one or more loads when failure is detected in the sensor of the output side; and
an emergency operation controller configured to control an operation in a constant current or constant voltage scheme based on the calculated substitution factor.

2. The apparatus according to claim 1, wherein the failure detector detects a position and kind of sensor in which the failure occurs.

3. The apparatus according to claim 2, wherein when failure is detected in the sensor of the input side which is a voltage sensor, the substitution factor calculator calculates the substitution factor based on a measurement value of a voltage sensor in the high voltage battery, an input power amount received from a high rank controller, and a measurement value of a current sensor of the input side in the converter.

4. The apparatus according to claim 2, wherein when the failure is detected in the sensor of the input side which is a current sensor, the substitution factor calculator calculates the substitution factor based on a measurement value of a current sensor in the high voltage battery, an input power amount received from a high rank controller, and a measurement value of a voltage sensor of the input side in the converter.

5. The apparatus according to claim 2, wherein when the failure is detected in the sensor of the output side which is a voltage sensor, the substitution factor calculator calculates the substitution factor based on an average value of measurement values of a voltage sensor connected to one or more loads, an output power amount received from a high rank controller, and a measurement value of a current sensor of the output side in the converter.

6. The apparatus according to claim 2, wherein when the failure is detected in the sensor of the output side which is a current sensor, the substitution factor calculator calculates the substitution factor based on a summation of measurement values of a current sensor connected to one or more loads, an output power amount received from a high rank controller, and a measurement value of a voltage sensor of the output side in the converter.

7. The apparatus according to claim 3, wherein when the calculated substitution factor is in a preset error range, the emergency operation controller controls operation in the constant voltage scheme by decreasing the range of fluctuation in an output voltage as compared to a normal operation case.

8. The apparatus according to claim 5, wherein when the calculated substitution factor is in a preset error range, the emergency operation controller controls the operation in the constant voltage scheme by decreasing the range of fluctuation in an output voltage as compared to a normal operation.

9. The apparatus according to claim 4, wherein when the calculated substitution factor is in a preset error range, the emergency operation controller controls the operation in the constant current scheme by determining a current limit.

10. The apparatus according to claim 6, wherein when the calculated substitution factor is in a preset error range, the emergency operation controller controls the operation in the constant current scheme by determining a current limit.

11. The apparatus according to claim 2, wherein the failure detector repeatedly detects the failure while having a preset period.

12. A method for controlling a converter, the method comprising:
detecting, by a failure detector, failure of at least one sensor included in an input side or an output side of a converter;
calculating, by a substitution factor calculator, a substitution factor based on a measurement value of a sensor in a high voltage battery connected to the converter when failure is detected in the sensor of the input side by the failure detector, and calculating the substitution factor based on measurement values of a sensor connected to one or more loads when failure is detected in the sensor of the output side; and
controlling, by an emergency operation controller, an operation in a constant voltage or constant current scheme based on the calculated substitution factor.

13. The method according to claim 12, wherein the step of calculating the substitution factor includes:
receiving an input power amount from a high rank controller;
receiving a measurement value from a voltage sensor in the high voltage battery when failure is detected in a voltage sensor of an input side in the converter, and receiving a measurement value from a current sensor in the high voltage battery when failure is detected in a current sensor of the input side in the converter; and
calculating a difference between a value calculated based on the input power amount and the measurement value of the current sensor of the input side in the converter, and the measurement value of the voltage sensor in the high voltage battery as the substitution factor when failure is detected in the voltage sensor of the input side in the converter, and calculating a difference between a value calculated based on the input power amount and the measurement value of the voltage sensor of the input side in the converter, and the measurement value of the current sensor in the high voltage battery as the substitution factor where failure is detected in the current sensor of the input side in the converter

14. The method according to claim 12, wherein the calculating of the substitution factor includes:
receiving an output power amount from a high rank controller;
receiving measurement values of a voltage sensor and a current sensor connected one or more loads; and
calculating an average value of the measurement values of the voltage sensor connected to the loads, calculating the calculated average value and the output power amount, and calculating a difference between a value obtained by the calculating of the calculated average value and the output power amount and the measurement value of the current sensor of the output side in the converter as the substitution factor when the failure is detected in the voltage sensor of the output side in the converter, and calculating a summation of the measurement values of the current sensor connected to the loads and the output power amount, and calculating a difference between a value obtained by the calculating of the summation of the measurement values of the current sensor connected to the loads and the output power amount and the measurement value of the voltage sensor of the output side in the converter as the substitution when failure is detected in the current sensor of the output side in the converter.
